(19) United States
(12) Patent Application Publication
(10) Pub. No.: US 2019/0015688 A1
(43) Pub. Date: Jan. 17, 2019

(54) Self Contained Stovetop Fire Suppressor with Sensor Triggered Shuttle Activation and Method

(71) Applicants: Christopher M. Stimek, Fort Worth, TX (US); Warren B. Johnson, Fort Worth, TX (US); Maisel N. Klutts, Melissa, TX (US); Donald W. Murray, Arlington, TX (US); Richard M. Anthony, River Oaks, TX (US)

(72) Inventors: Christopher M. Stimek, Fort Worth, TX (US); Warren B. Johnson, Fort Worth, TX (US); Maisel N. Klutts, Melissa, TX (US); Donald W. Murray, Arlington, TX (US); Richard M. Anthony, River Oaks, TX (US)

(73) Assignee: WilliamsRDM Inc., Fort Worth, TX (US)

(21) Appl. No.: 16/120,354

(22) Filed: Sep. 3, 2018

Related U.S. Application Data
(60) Provisional application No. 62/404,232, filed on Oct. 5, 2016.

(51) Int. Cl. A62C 3/00

(52) U.S. Cl. CPC A62C 3/006

(57) ABSTRACT

An automatic stovetop fire suppressor with sensor triggered activation and method are provided herein. A combination of sensor types is housed within a self-contained fire suppressor, collecting data from the stovetop environment. Sensor types include temperature, light, and infrared. The fire detection method affords expedient fire state determination with discrimination from changes in ambient light, camera flashes, and non-fire heat sources. A bottom lid is secured to a bottom of a can, forming a closed container. A fire suppressing agent is housed within the closed container. From sensed data, the presence of a stovetop fire is assessed. When a fire condition is determined, an electronic match triggers a mechanical shuttle. The fire suppressing agent and battery power are stored in the closed container from manufactured end to activation of the suppressor in a fire condition.

### CROSS REFERENCE TO RELATED APPLICATIONS

This patent application is a Divisional Application and claims priority to U.S. patent application Ser. No. 15/606,293, filed 26 May 2017, the entire contents of which are incorporated herein by reference; and U.S. patent application Ser. No. 15/606,293 claims priority to U.S. Provisional Patent Application No. 62/404,232, filed 5 Oct. 2016, the entire contents of which are incorporated herein by reference.

### FIELD OF THE INVENTION

The present invention relates to a device and method of fire suppression, and more particularly to an automatic self-contained stovetop fire suppressor.

### BACKGROUND OF THE INVENTION

Stovetop fires are a well-known residential and commercial hazard. An unattended stovetop fire, for example a grease fire, can lead to structural damage or injury. Even if a stovetop fire is attended, an automatic extinguishing method may be more effective and expedient compared to manual means. Conventional fire extinguishers can provide efficient and automatic stovetop fire suppression and include, for example, the automatic stovetop fire extinguisher taught by Stevens and Weintraub, U.S. Pat. No. 7,472,758 and conventional stovetop fire suppressor, such as a STOVETOP FIRESTOP® fire suppressor (WilliamsRDM, Inc., Fort Worth, Tex., USA). A number of conventional automatic stovetop fire extinguishers, which mount above the stovetop surface, are available. These include: U.S. Pat. No. 6,276,461 to Stager; U.S. Pat. No. 6,105,677 to Stager; U.S. Pat. No. 5,899,278 to Mikulec; and U.S. Pat. No. 7,610,966 to Weintraub et al. The array of conventional fire suppression systems vary from pendulum swing apparatus (Stager '461), to canister systems (Weintraub '966 and Stager '677), or to tube connecting systems for liquid effluent (Mikulec '278). The array of conventional fire suppression systems vary from activation by melting of a fusible pin (Stager '461), to melting a solder fusible plug (Stager '677), to burning of a fuse (Stevens '758), or to activating via a glass bulb fuse mechanism (Mikulec '278). Stovetop fire suppression systems further include, for example, sensor triggered stovetop shutoff to Stell et al, U.S. Pat. No. 7,934,564. Conventional fire suppressors, which are particularly well suited to a stovetop environment are mounted above the stovetop include, for example, Weintraub '966.

For a multitude of situations, it would be desirable to provide an efficient, economical, automatic, and easy to use stovetop fire suppresser. Expediency in fire detection and subsequent automatic fire suppressor activation is desirable for a multitude of reasons to include property preservation. Expediency is desirably tempered with fire detection accuracy, avoiding deployment of a fire suppressor under a non-fire condition.

### SUMMARY OF THE INVENTION

The present invention provides sensitive activation of a self-contained fire suppressor that provides controlled release of a fire suppressing agent. Embodiments of the present invention may have any of the aspects below. Aspects of the present invention are provided for summary purposes and are not intended to be all inclusive or exclusive. Embodiments of the present invention may have any of the aspects below.

The present invention incorporates a set of sensors and an activation process which incorporates the release of compressed spring energy to deploy, to lower, a bottom lid. In addition, determination of a fire condition in accordance with the methods and sensors taught herein may provide a fire detection invention for alternate applications.

One aspect of the present invention is to provide a user friendly method of suppressing a stovetop fire.

Another aspect of the present invention is to provide an automated release of fire suppressing agent in the presence of a stovetop fire.

Another aspect of the present invention is a mounting device and method, or compatibility with the same, which affords full and proper function of a stovetop fire suppressor mounted beneath a vent hood.

Another aspect of the present invention is to be compatible with a convenient mounting device for a micro-hood stovetop environment.

Another aspect of the present invention is mounting a sensor board on standoffs that are integral to the cone-shaped bottom lid.

Yet another aspect of the present invention is to provide a consistent release of fire suppressing agent upon activation of the stove top fire suppressor.

Another aspect of the present invention is to provide a gradual release of fire suppressing agent over time.

Another aspect of the present invention is to provide a desired distribution pattern of fire suppressing agent in a fire condition.

Another aspect of the present invention is to provide a closed fire extinguishing container in an inactivated state.

Another aspect of the present invention is the ability to use off the shelf parts in the stovetop fire suppressing device and the sensor trigger.

Yet another aspect of the present invention is to provide a stovetop fire suppressor using a combination of ready-made and custom made parts.

Another aspect of the present invention is a relative ease of use in employment of the present invention in field applications.

Still another aspect of the present invention is the release of compressed spring energy to activate the stovetop fire suppressor.

Still another aspect of the present invention is the use of a mechanical shuttle activation of self-contained fire suppressor.

Another aspect of the present invention is the containment of the fire suppressing agent in a closed container from manufactured end to activation of the device in a fire condition.

Another aspect of the present invention is open air exposure of a sensor above the stovetop cooking surface.

Another aspect of the present invention is the positioning of fire related sensors on a fire suppressor bottom outer surface.

Another aspect of the present invention is the use of an ambient temperature sensor above the stovetop cooking surface.

Another aspect of the present invention is the use of thermopile sensor above the stovetop cooking surface.

Another aspect of the present invention is the use of a visible light phototransistor sensor above the stovetop cooking surface.

Another aspect of the present invention is the use of a Near Infrared light sensor above the stovetop cooking surface.

Another aspect of the present invention is the use of a phototransistor sensitive to 940 nm with a daylight filter package for a sensor above the stovetop cooking surface.

Another aspect of the present invention is the use of a combination of sensors from any of: an ambient temperature; a thermopile sensor; a visible light phototransistor sensor; and/or a Near Infrared light sensor above the stovetop cooking surface.

Another aspect of the present invention is the use of one each of: an ambient temperature sensor; a thermopile sensor; a visible light phototransistor sensor; and a Near Infrared light sensor above the stovetop cooking surface.

Still another aspect of the present invention is the potential use of heat sensitive, viscous, fuse for triggering of mechanical shuttle activation.

Still another aspect of the present invention is the use of an electronic match for triggering of mechanical shuttle activation.

Still another aspect of the present invention is the use of an electronic match in tandem with a heat sensitive fuse for triggering of mechanical shuttle activation.

Another aspect of the present invention is to provide sensitive detection of a grease fire in various cooking vessels while discriminating alcohol based flames.

Another aspect of the present invention is to use low cost off the shelf sensors.

Another aspect of the present invention is to consider wavelength of detected light.

Another aspect of the present invention is to discern a heat/light source, flames, alcohol flames, heat from electric stove burners, steam, ambient light, changes in ambient light, strobe lights, and camera flashes.

Another aspect of the present invention is to accommodate local environmental lighting such as incandescent, halogen, light emitting diode, and fluorescent.

Another aspect of the present invention is to avoid false stovetop fire detection to include, for example, transitions from a cool indoor environment to a brightly lit outdoor environment or placement in close proximity to, for example, a 500 watt halogen light.

Another aspect of the present invention is to provide a fire suppressor with sensor triggered shuttle activation which operates via a self-contained power supply.

Another aspect of the present invention is the use of one or more batteries as the power supply.

Another aspect of the present invention is a five year or better battery life.

Another aspect of the present invention is system event logging.

Another aspect of the present invention is the use of a microcontroller.

Another aspect of the present invention is rapid detection of a stovetop fire and activation of the mechanical shuttle.

Embodiments of the present invention may employ any or all of the exemplary aspects above. Those skilled in the art will further appreciate the above-noted features and advantages of the invention together with other important aspects thereof upon reading the detailed description that follows in conjunction with the drawings, which illustrate, by way of example, the features in accordance with embodiments of the invention. The summary is not intended to limit the scope of the invention, which is defined by the claims herein.

### BRIEF DESCRIPTION OF THE FIGURES

For more complete understanding of the features and advantages of the present invention, reference is now made to the detailed description of the invention along with the accompanying figures, wherein:

FIG. 1A shows a bottom perspective of an automatic stovetop fire suppressor in a closed state with a cone shaped bottom lid, a fuse, and a shuttle actuator, in accordance with an exemplary embodiment of the present invention;

FIG. 1B shows a bottom perspective of an automatic stovetop fire suppressor in an open activated state with a cone shaped bottom lid, a fuse, and a shuttle actuator, in accordance with an exemplary embodiment of the present invention;

FIG. 2 shows a bottom view of an automatic stovetop fire suppressor in a closed state with an inner cone shaped bottom and sensor triggered shuttle activation, in accordance with an exemplary embodiment of the present invention;

FIG. 3 shows a side perspective view of an automatic stovetop fire suppressor in a closed state with an inner cone shaped bottom and sensor triggered shuttle activation, in accordance with an exemplary embodiment of the present invention;

FIG. 4 shows an exploded view of a shuttle actuated fire suppressor device in three dimensions from a bottom perspective without the bottom sensor plate, in accordance with an exemplary embodiment of the present invention;

FIG. 5A shows an exploded view of a shuttle actuated fire suppressor device with sensor plate in three dimensions from a bottom perspective, in accordance with an exemplary embodiment of the present invention;

FIG. 5B shows a cross sectional view taken along line A-A in FIG. 2 of the an exemplary embodiment of the present invention;

FIG. 5C shows an inner side of a bottom sensor plate, in accordance with an exemplary embodiment of the present invention;

FIG. 6 shows a bottom view of a sensor plate, in accordance with an exemplary embodiment of the present invention;

FIG. 7 shows a block diagram of hardware components, in accordance with an exemplary embodiment of the present invention;

FIG. 8 shows an exemplary audible signal pattern, emitted upon deployment of a stovetop fire suppressor, in accordance with an exemplary embodiment;

FIG. 9 shows an exemplary method of sensor based fire detection in an algorithm view, in accordance with an exemplary embodiment of the present invention;

FIG. 10 is a block diagram of an exemplary method of detecting a presence of a fire's flicker, in accordance with an exemplary embodiment of the present invention; and

FIG. 11 is a block diagram of a method of activating a stovetop fire suppressor, in accordance with an exemplary embodiment of the present invention.

### DETAILED DESCRIPTION OF THE INVENTION

The invention, as defined by the claims, may be better understood by reference to the following detailed description. The description is meant to be read with reference to the figures contained herein. This detailed description relates to examples of the claimed subject matter for illustrative purposes. The specific aspects and embodiments discussed herein are illustrative of ways to make and use the invention, and are not intended to limit the scope of the invention. Same reference numbers across views refer to like elements for ease of reference. Reference numbers may also be unique to a respective embodiment. Implementations described below are exemplary and are provided to enable persons skilled in the art to make or use the embodiments of the invention and are not intended to limit the scope of the invention, which is defined by the claims.

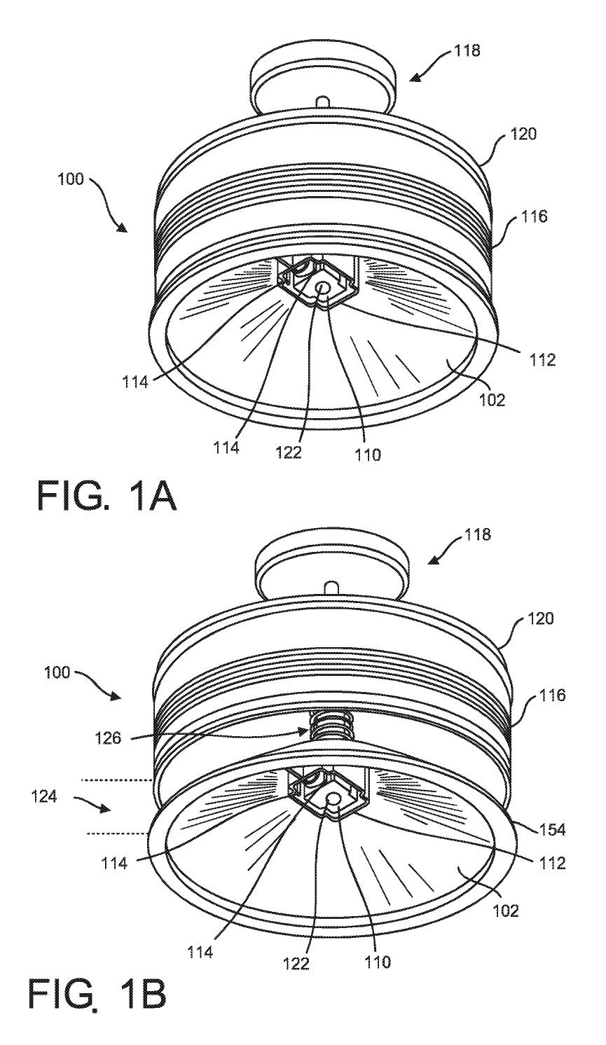

Conventional fire suppressors, STOVETOP FIRESTOP® fire suppressor (WilliamsRDM Inc., Fort Worth, Tex., USA), which are particularly well suited to a stovetop environment, include a container of an extinguishing agent mounted to a vent hood above the stovetop and activated by a fuse. An example of such a suppressor is shown in FIGS. 1A and 1B. FIG. 1A shows a bottom perspective of an automatic stovetop fire suppressor 100 in a closed state with a cone shaped bottom lid 102, a fuse 114, and a shuttle actuating assembly 106, in accordance with an exemplary embodiment of the present invention. FIG. 1A shows a cone shaped bottom lid 102 with a shuttle housing 110 at center. A splash shield 112 surrounds the shuttle housing 110 and two ends of a fuse 114 extend out of the bottom of shuttle housing 110 facing the stovetop surface when mounted for fire suppression. The lid 102 is sealed to a container sidewall 116. A mounting assembly 118 is connected to the shuttle actuated fire suppressor 100 and is shown above a container top wall 120. A center pin 122 located near the center of the shuttle housing 110 secures the shuttle assembly, not shown, to the fire suppressor 100.

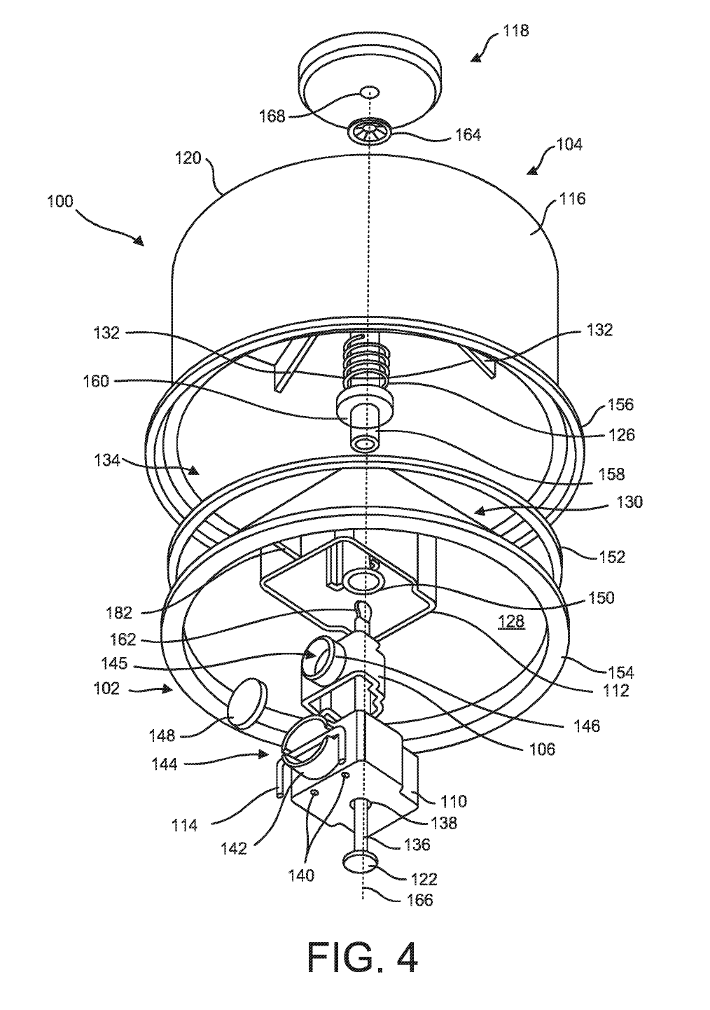

FIG. 1B shows a bottom perspective of an automatic stovetop fire suppressor 100 in an open activated state with a cone shaped bottom lid 102, a fuse 114, and a shuttle actuation assembly 106, shown particularly in FIG. 4, housed in shuttle housing 110, in accordance with an exemplary embodiment of the present invention. FIG. 1B shows the bottom lid 102 dropped below sidewall 120 forming a radial opening 124. Seen through the opening is a spring 126. The spring 126 is compressed in the closed state of the fire suppressor 100 but when the fuse 114 lights and the shuttle 106 displaces the support holding the spring in compression, the spring 126 expands to break the seal 152, shown in FIG. 4, between the lid circumference 154 and the cylindrical sidewall 116 and to lower the cone shaped bottom lid 102. Fire suppressing powder, not shown, flows out of the radial opening 124 when the shuttle actuated stovetop fire suppressor 100 activates, as shown in FIG. 1B. The splash guard 112 and shuttle housing 110 remain in their same position relative to the cone shaped bottom lid 102. The head of the center pin 122 is shown near the center of the shuttle housing 110. A mounting assembly 118 secures the fire suppressor 100 above the stovetop surface in practice. Both ends of a fuse 114 extend from the shuttle housing 110.

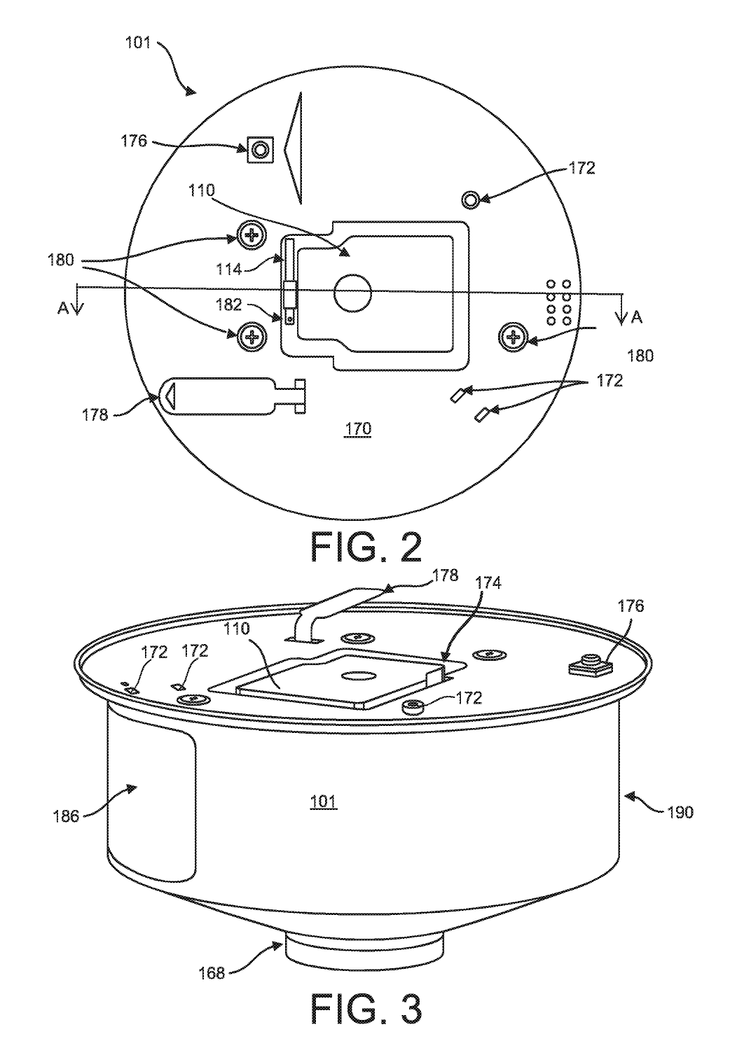

An exemplary embodiment of the present invention provides a low power fire sensor circuit board 170, shown in FIG. 2, secured to the bottom of stovetop fire suppressor unit, such as the suppressor 100 of FIG. 1A. In field tests with an exemplary sensor board 170, shown for example in FIG. 2, detection of a stovetop fire and the deployment of the stovetop fire suppressor was efficiently executed in a desired manner.

FIG. 2 shows a bottom view of an automatic stovetop fire suppressor 101 in a closed state with an inner cone shaped bottom, not shown, and sensor 172 triggered shuttle activation, in accordance with an exemplary embodiment of the present invention. A fire detection sensor board 170 is secured to the bottom of the stovetop fire suppressor, in accordance with an exemplary embodiment of the present invention. In accordance with an exemplary embodiment of the present invention, the fire detection system collects data from a combination of sensors 172. A plurality of screws 180 facilitates secure attachment of the sensor board 170 to the bottom of the stovetop fire suppressor 101. However other types of mounting provisions such as use of adhesive, snap fit mechanism or the like can be used to mount the sensor plate 170 to the bottom of the stovetop fire suppressor 100 without departing from the scope and spirit of the invention. Further, across exemplary embodiments of the present invention, sensors 172 may be somewhat cluster or dispersed across the bottom plate 170. Also shown are an electric match 182 and a fuse 114. A push to test button 176 is shown above the shuttle housing 110 and a pull tab 178 is shown below the shuttle housing 110. In accordance with an exemplary embodiment, the pull tab 178 is pulled to arm the sensor board 170.

Sensors 172 may include: an ambient temperature sensor, a thermopile or far infrared object sensor, a visible light sensor or phototransistor, and a Near Infrared light sensor

FIG. 3 shows a side perspective view of an automatic stovetop fire suppressor 101 in a closed state with an inner cone shaped bottom and sensor triggered shuttle activation, in accordance with an exemplary embodiment of the present invention. In accordance with an exemplary embodiment of the present invention, a bottom sensor plate 170 covers the bottom of the stovetop fire suppressor 101, leaving a center opening/hole 174. The hole 174 disposed in the plate 170 accommodates the shuttle housing 110. In accordance with the exemplary embodiment of FIG. 3, the circuit board and sensor board are a single board that forms the sensor plate 170. Features on the bottom, exposed outer side, of the bottom plate 170 are the sensors 172, push to test button 176 and a pull tab 178. The pull tab 178 is pulled to arm the sensor board 170 and maybe pulled after the unit is installed, for example, above the stovetop. In accordance with an exemplary embodiment, the push test button 176 is also a silence button for a low battery audio indicator. In accordance with an exemplary embodiment a conformal coating, not shown, of the bottom sensor plate 170 encloses the plate 170 and provides moisture resistance and environmental protection in a cooking environment, which may, for example, include steam. In accordance with an exemplary embodiment, a silicone type conformal coating is used, at least in part, for its moisture resistance.

FIG. 4 shows an exploded view of a shuttle actuated fire suppressor device 100 from a bottom perspective, in accordance with an exemplary embodiment of the present invention. An outer side 128 of the cone lid 102 faces the negative Z direction in the present view, while an inner side 130 faces into the can interior 134. The container has a top wall 120 and integral sidewalls 116. Ribs 132, also shown inside the can 134, provide structural support. In accordance with an exemplary embodiment, ribs 132 may be integral part of the top wall 120 of the can 104 and/or to the side wall 116. In accordance with an exemplary embodiment, there are three ribs 132 spaced 120 degrees apart. In accordance with another exemplary embodiment, the cylindrical sidewall 116 may be corrugated to increase, for example, stiffness and to keep the cylindrical shape and maintain the lid 102 to sidewall interface and seal 152.

In accordance with the exemplary embodiment of FIG. 4, an off the shelf nail serves as the center pin 136 with a head 122 and is configured during assembly. The center pin 136 fits inside a bottom hole 138 of the shuttle housing 110 with the pin head 122 having greater diameter than the bottom hole 138.

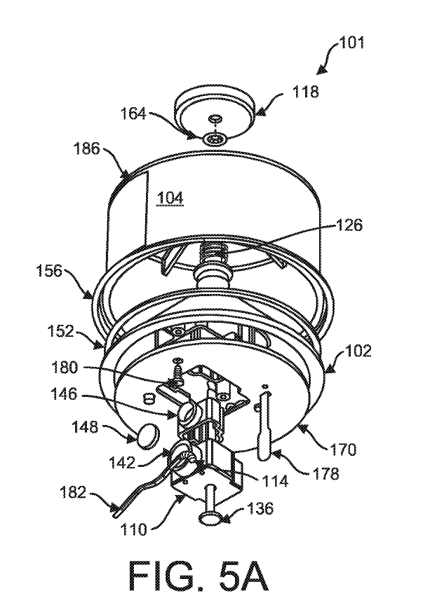

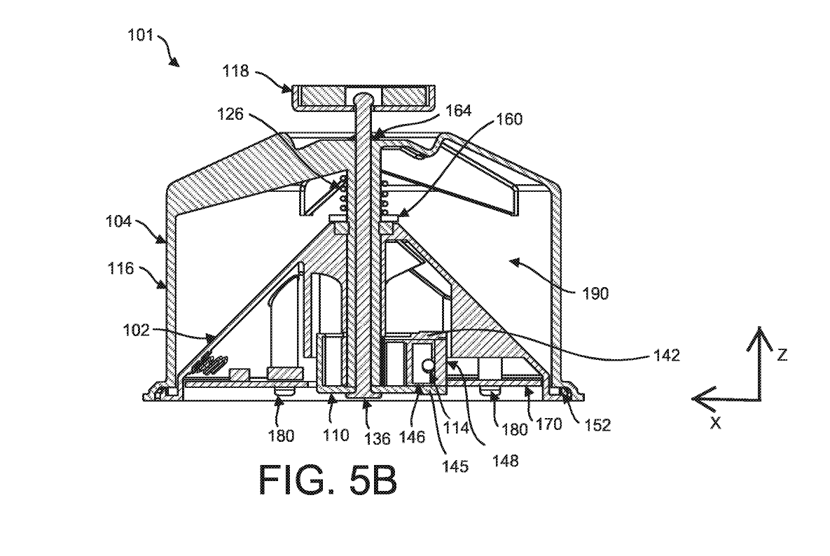

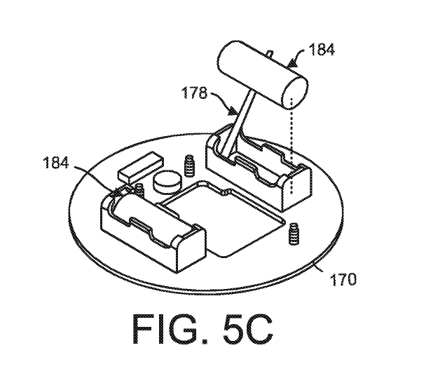

Also shown in FIG. 4 are two vent holes 140 in the bottom of the shuttle housing 110. The shuttle housing 110 has a hollow cylinder 142 which serves as the charge housing. A notch 144 is cut across a diameter of the cylinder 142. The notch 144 secures both the ends of a fuse 114 in place. In accordance with an exemplary embodiment, one end of the fuse 114 is replaced with an electronic match 182, shown in FIG. 5A. Referring again to FIG. 4, shuttle 106 fits inside shuttle housing 110, when the fire suppressor is assembled. Before placing the shuttle 106 into its housing 110, a charge, not shown, is secured in the compartment 145 of the charge cup 146 of the shuttle 106. The charge filled shuttle charge cup 146 is pushed into charge housing 142 and a cap 148 closes the charge housing 142.

The shuttle assembly 106 and shuttle housing 110 fit within a splash guard 112. As the shuttle assembly 106 is raised to the bottom lid 102 a center guide 150, integral to or affixed to, the lid 102 meets upon a corresponding top surface portion of the shuttle housing 110. A seal 152 fits between a lid edge 154 and the sidewall bottom edge 156 as the lid 102 closes to the can 104 forming a closed container.

Shown in the can interior 134 and extending down from the top wall 120 is the center post 158. In accordance with an exemplary embodiment the center post 158 is integral to the can 104 and in an alternate embodiment a center post 158 is affixed to the top wall 120. A washer 160 is shown around the post 158 and below a compression spring 126. The compression spring 126 circumscribes the center post 158. The center post 158 fits within the hollow center of the center guide 150 and when the fire suppressor 100 is closed the center posts 158 meets the bottom inner side of the shuttle housing 110. Referring again to FIG. 4, the center pin 136 is shown with shoulder 162 formed. In practice the shoulder 162 is formed during assembly of the fire suppressor 100. The shaft of the center pin 136 rises through the shuttle housing hole 138 through the shuttle 106, through center guide 150, through the center post 158 and exits out of the top wall 120. A push nut 164 is lowered and the stovetop container 104 is held closed between the push nut 164 and the head of the center pin 122. The shaft then passes through the hole in the magnet housing 168 and is flattened to extend past the magnet housing hole diameter but to stay within the inner hole of the magnet, not shown. The container 104 is mounted above the stove top via the mounting assembly 118. The center pin 136 rises through axial center 166 of the stovetop fire suppressor.

FIG. 5A a shuttle actuated fire suppressor device 101 with sensor plate 170 from a bottom perspective in an exploded view, in accordance with an exemplary embodiment of the present invention. An exemplary embodiment of the present invention comprises a small battery powered sensor board 170 attached to the bottom of a cone-lid stovetop fire suppressor unit 101. When an exemplary fire detection method determines a fire exists from evaluation of sensor data, an electric match 182 is fired, which deploys the fire suppressing unit 101. The viscous fuse 114 is also present, in accordance with an exemplary embodiment, for backup activation. In accordance with the present invention, whether fuse 114 or electronic match 182 activates the stovetop fire suppressor 101, the unit deploys in like fashion with shifting of the shuttle 106 and lowering of the cone shaped bottom lid 102 under release of spring compression 126. While in an exemplary embodiment of the present invention, the sensor board 170 triggers an electric match 182, in alternate embodiments additional devices such as: relays; alarm systems; lights; and E-mails may be triggered.

Also shown in FIG. 5A is a mounting assembly 118 and a push nut 164 which mates with center pin 136 to secure the fire suppressor 101 closed. The shuttle 106, shown in FIG. 4, is positioned to fit into its shuttle housing 110 with the fuse 114 and electric match 182 inserted in a the charge housing 142. Charge cup 146 fits into and cap 148 closes the charge housing 142. A screw 180 and a pull tab 178 extend down from the sensor board 170. Seal 152 is above the lid 102 and below the sidewall bottom edge 156. In accordance with an exemplary embodiment, a label 186 with user instructions may be provided on the can 104.

FIG. 5B shows a cross sectional view taken along line A-A of FIG. 2 of a stovetop fire suppressor in a closed state, in accordance with an exemplary embodiment of the present invention. This cross sectional view shows the cross section for the XZ plane at axial center. The container or can 104 of the stovetop fire suppressor 101 has a cylindrical side wall 116. With the stovetop fire suppressor in its closed position, spring 126 is in a compressed state. A washer 160 butts up against the compression spring 126, −Z, and the washer sits atop an inner top side of the cone lid 102. Center pin 136 extends into the mounting assembly 118 and push nut 164 secures the can and lid to form the closed container. Inner cavity 190 is filled with a fire suppressing agent, agent not shown.

Along the bottom, −Z in the X direction, two of three screws 180 is shown securing the sensor plate 170 to the cone lid 102. The shuttle housing 110 sits upon the center pin 136. Charge cup 146 is pushed into charge housing 142 and cap 148 closes the charge housing 142. The fuse 114 is in place to activate the charge, charge not shown. The electric match 182 is not visible in this view.

FIG. 5C shows an inner side of a bottom sensor plate 170, in accordance with an exemplary embodiment of the present invention. The sensor board 170 is powered from two 1000 mAh 1.5V “N” cell batteries 184. Such batteries 184 are available off the shelf and may fit inside of an exemplary stovetop fire suppressor's cone shaped bottom lid 102, in accordance with an exemplary embodiment of the present invention. Also shown is the pull tab 178, which is pulled to arm the sensor board 170 for use.

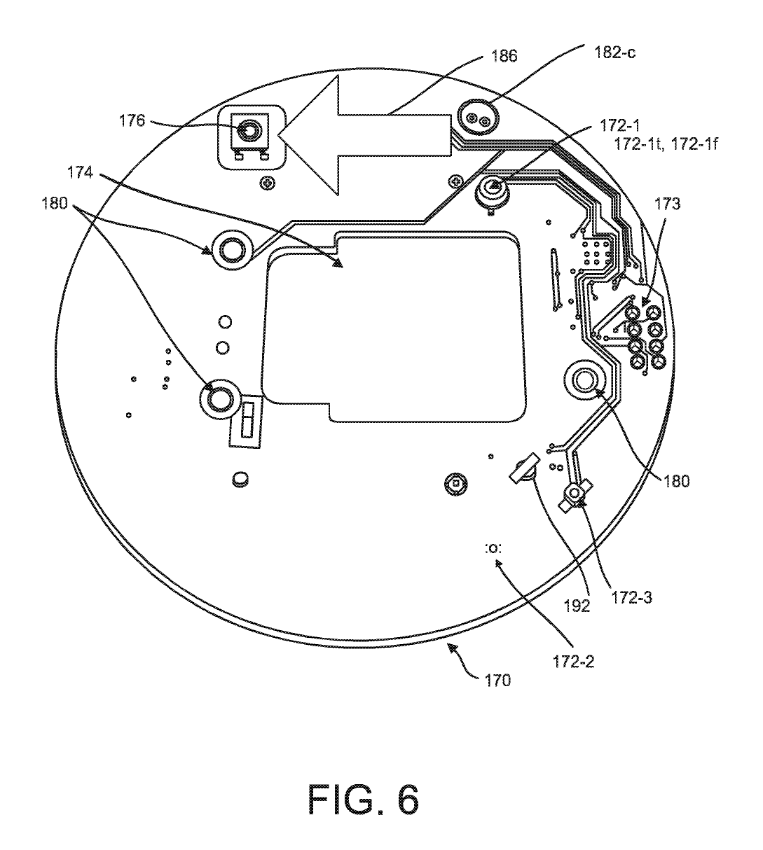

FIG. 6 shows the bottom of the sensor board 170 and placement of the various sensors 172-1 to 172-3, in accordance with exemplary embodiments of the present invention. In accordance with an exemplary embodiment, four individual sensors may be mounted on the sensor board, or in alternate exemplary embodiments, one sensor unit may incorporate two types of sensors. In accordance with alternate exemplary embodiments of the present invention, any of sensors 172-1-172-3 may be mounted and connected in alternate positions across the bottom plate 170. An exemplary ambient light sensor 172-2 may be a low profile phototransistor photo detector, incorporating a phototransistor detector chip, suppressor, KDT00030 (ON Semiconductor, Inc., Phoenix, Ariz., USA). Far infrared sensor 172-1f may also incorporate an ambient temperature sensor 172-1t. The Far infrared sensor 172-1f can measure an object temperature, and in accordance with an exemplary embodiment may be a ZTP-135SR-IR Sensor (Amphenol Advanced Sensors, Inc., St. Marys, Pa., USA). An exemplary ambient temperature sensor 172-1t may be incorporated into the Far infrared sensor. In accordance with the embodiment of FIG. 6, a label 186 indicating the user button 176 interface may be provided. And an exemplary near infrared sensor 172-3 may be a subminiature plastic silicon Infrared Phototransistor QSB363GR (ON Semiconductor, Inc., Phoenix, Ariz., USA). A connector for the electric match 182-c is shown above the ambient temperature sensor 172-1t. In accordance with an exemplary embodiment, a port connector 173 is provided for programming or manufacturer testing. In still alternate embodiments, an infrared light emitting diode 192 for self-testing of the unit. Also shown are three mounting screws 180 and an opening 174 for the shuttle assembly in the plate's 170 center.

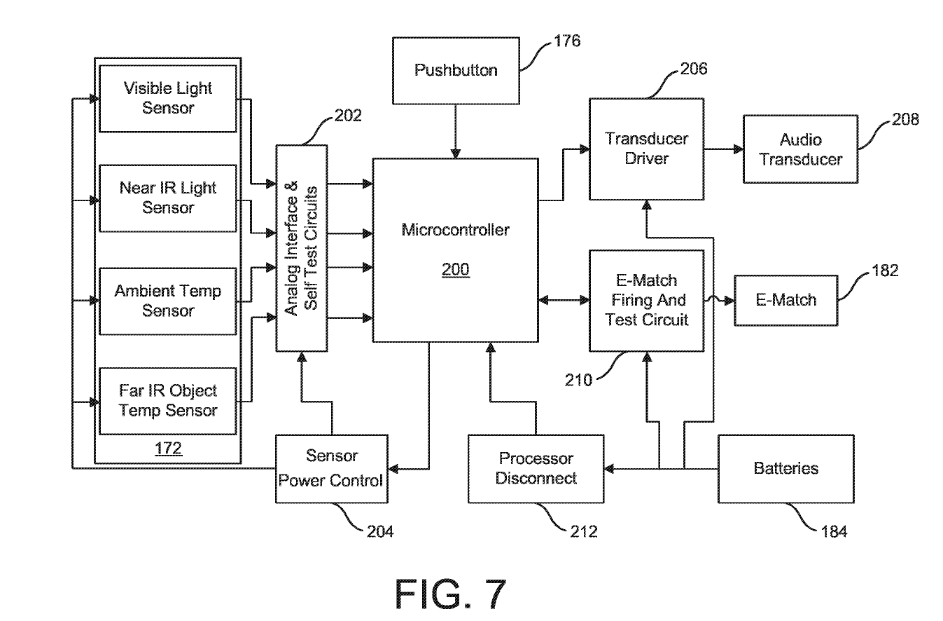

FIG. 7 shows a block diagram of a fire sensor board hardware, in accordance with an exemplary embodiment. The output of the four sensors 172 goes through analog signal conditioning 202 circuitry before being sent to the microcontroller's 200 analog to digital converter inputs. A self-test circuitry 202 covers the additional hardware necessary to self-test the sensors 172 which may vary across alternate embodiments. For example, in accordance with an exemplary embodiment additional hardware includes an infrared light emitting diode 192 used to illuminate the visible light and Near Infrared light sensor/s to perform a self-test. Battery 184 powered embodiments of the present invention may incorporate extensive power management techniques to promote long battery life. Such hardware to perform these tasks may be incorporated into the Sensor Power Control block 204. In part, this block controls power to the sensors and amplifiers and ensures they are turned off when not in use. In a non-battery powered embodiment and application a duty cycle of the sensors and/or analog hardware may be omitted. In turn, the Sensor Power Control block 204 may be modified or omitted. In accordance with alternate embodiments, reduced battery load can be met by a smaller battery supply.

Referring to FIG. 7, in accordance to an exemplary embodiment, the user input is a single push button 176 which when pressed and held for 3 s triggers a self-test. Alternate user input may include pressing the push button 176 once to silence a low battery alert for 36 hours, for example. In accordance with an exemplary embodiment, self-test faults cannot be silenced. In accordance with an exemplary embodiment, the sensor board automatically performs a self-test of all of the hardware once a week. In accordance with an exemplary embodiment, the sensor board hardware includes an audio transducer 208, which is connected to a transducer driver 206. Wherein the transducer driver 206 upon receiving a signal from the microcontroller 200, activates the audio transducer 208 to alert the user of various events using beep patterns which may include: one beep once a minute, indicating a low battery; two successive beeps once a minute, indicating a system fault; and a fire condition tonal pattern, indicating a detected fire condition, however any way of alert mechanism is used without departing from the scope and spirit of the invention.

In accordance with an exemplary embodiment of the present invention, as shown in FIG. 7, when a fire is detected the microcontroller 200 fires the E-match 182 via E-match Firing and Test Circuit 210, which in turn, activates the shuttle. Experimental testing of the E-match 182, firing circuits 210, and battery 184 have been performed and results indicate satisfactory function to fire the E-match 182 upon fire detection specifications. Additionally, in accordance with an exemplary embodiment, many components on the sensor board can be tested to ensure they are working properly. In accordance with alternate embodiments such testing maybe omitted.

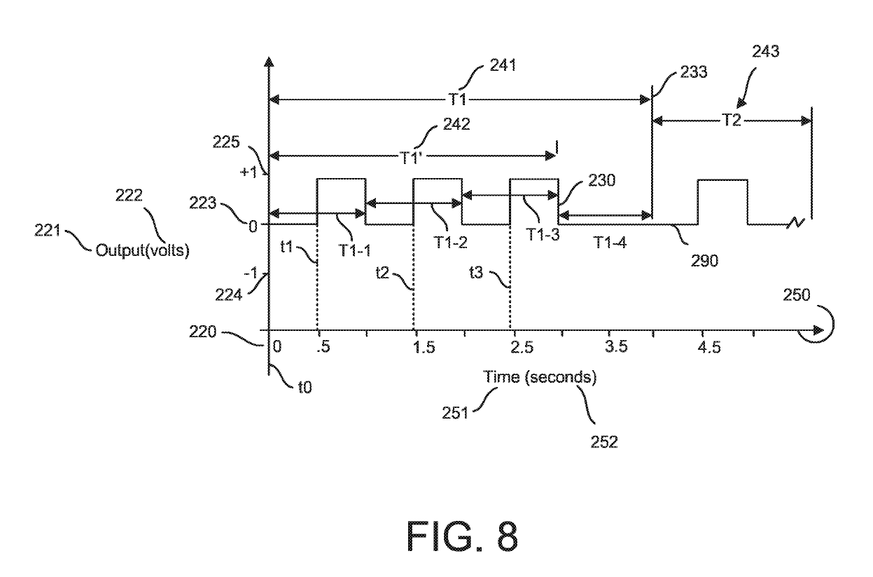

In accordance with an exemplary embodiment, the Temporal-Three (T-3) alarm signal 300, shown in FIG. 8, (ISO 8201 and ANSI/ASA S3.41 Temporal Pattern) is broadcast for a fire condition alert signal via audio transducer 208, shown for example in FIG. 7. Referring again to FIG. 8. a fire condition alert signal 290 as a function of time is provided, in accordance with an exemplary embodiment of the present invention. Output 221 in volts 222 is shown as the ordinate axis 220 as a function of time 251 in seconds 252 on the abscissa axis 250. In accordance with the exemplary embodiment of FIG. 8, a square wave from zero 223 to near +1 volts 225 is output from the microcontroller. An entire first period T1 241 is shown from 0 seconds at t0 to 4.0 seconds 233. The period T1 starts with a zero volt output and goes hi at time equals 0.5 seconds for 0.5 seconds T1-1, and the same square wave repeats for T1-2 and T1-3 with the output switching hi at t2 1.5 seconds and t3 2.5 seconds. At 3.0 seconds, the end of T1-3, 230 and T1′ 242, the output drops to zero volts and holds a zero volt output for 1 second T1-4 from 3.0 to 4.0 seconds 233. The signal of three square waves followed by a zero volt dead time equal to a square wave duration repeats, for example at T2 243. In alternate embodiments, three identical pulses followed by a dead time near that of a single wave period will form a fire alert signal. In still alternate embodiments, the signal need not comprise square waves and the total T1 period my range from, for example, 2.5 to 4.5 seconds.

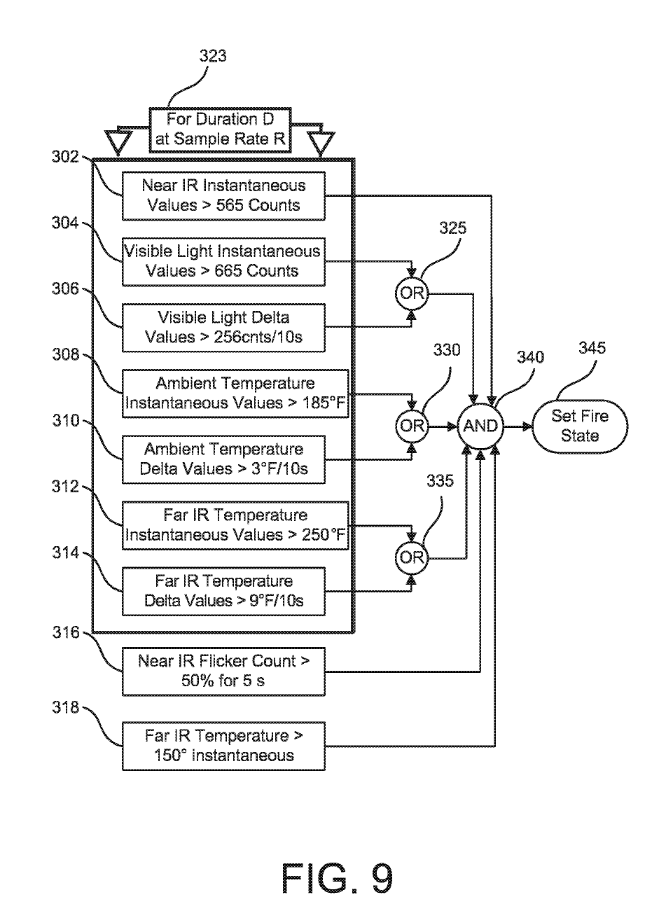

FIG. 9 shows an exemplary method of sensor based fire detection in an algorithm view, in accordance with an exemplary embodiment of the present invention. Nine fire factors may be considered in the exemplary method of determining a fire state from the sensor data of four different sensors, each sensor of a different type. The exemplary method includes: assessing Far infrared thermopile sensor data and comparing data to a Far infrared instantaneous threshold 312; assessing Far infrared thermopile sensor data and calculating a delta change in temperature with respect to time; and comparing calculated data to a respective rate of rise, or delta, threshold 314. In accordance with an exemplary embodiment the thermal instantaneous threshold for the thermopile sensor data may be 250 degrees Fahrenheit (F) 312. The Far infrared thermopile sensor is used to measure an object temperature of the pan/stove.

In accordance with an exemplary embodiment, the algorithm method further includes: assessing ambient temperature sensor data for a rate of rise of the ambient temperature greater than a rate threshold 310; and assessing ambient temperature for a value greater than a, instantaneous threshold value 308. In accordance with an exemplary embodiment, the threshold ambient temperature may be 185 degrees F.

In accordance with an exemplary embodiment, the algorithm method further includes: assessing visible light sensor data for an increase in visible light above a threshold, independent of rate of increase 304, or the visible light sensor data is compared to a threshold instantaneous visible light value; calculating a delta visible light from sensed visible light data and comparing the calculated delta to a threshold delta value 306. In accordance with exemplary embodiments of the present invention, not all sensor data is converted to units of measurement, such as degrees Fahrenheit. The ambient temperature sensor data and the Far infrared object temperature data are converted to degrees Fahrenheit before processing but the light sensor is left in Analog to Digital Converter (ADC) Counts, which for a 10 bit ADC can range from 0 to 1023. Foregoing conversion or normalization may reduce processing load. Further, because the light sensor output of the exemplary sensors is fairly linear, lack of conversion is a workable alternative. In contrast, exemplary temperature sensors tend to be non-linear and some form of data conversion is desired. Referring again to FIG. 9, the threshold instantaneous visible light value may be 665 counts 304.

In alternate embodiments more sensor data or all sensor data may be converted to measurement units. In turn, at least some, threshold values would be adjusted.

In accordance with an exemplary embodiment, the algorithm method further includes: assessing Near infrared sensor data and comparing the sensed value to an instantaneous threshold value 302. Like the visible light sensor data, the Near infrared data is left in ADC counts. In accordance with an exemplary embodiment, the threshold instantaneous value is 565 counts 302. In accordance with an exemplary embodiment, the Near infrared sensor looks for a rise above a certain threshold in the 940 nm wavelength of light. In accordance with an exemplary embodiment, the Near Infrared light sensor 172-3, shown for example in FIG. 6, may be a phototransistor sensitive to a 940 nm wavelength with daylight filter.

The above seven data comparisons are performed for a given duration D at a given sample rate R 323. In accordance with an exemplary embodiment, the duration D is 1.25 seconds and the sample rate is 4 Hz, which yields five consecutive samples. In alternate embodiments, the sample rate may be as slow as 1 Hz or as fast as 20 Hz. The duration D can also vary and can be determined, in part, by the sample rate and the number of consecutive samples desired for condition confirmation. In accordance with an exemplary embodiment, 2 consecutive samples are desired. In accordance with a higher processing rate, 10 consecutive samples may be desired for comparisons.

In accordance with exemplary embodiments, such as the method of FIG. 9, either exceeding instantaneous threshold or exceeding the respective Delta threshold may satisfy the condition for fire factor present. More particularly, turning to visible light, shown in FIG. 9, if instantaneous visible light exceeds threshold 304 OR if visible light delta calculated from sample data exceed its threshold delta value 306 for duration D 323, then the visible light fire factor is met 325. Alternatively, if both visible light conditions are met, the visible light fire factor is met 325. Turning to ambient temperature, shown in FIG. 9, if instantaneous ambient temperature data exceeds threshold 308 OR if ambient temperature delta calculated from sample data exceed its threshold delta value 310 for duration D 323, then the visible light fire factor is met 330. Alternatively, if both ambient temperature conditions are met, the ambient temperature fire factor is met 330. Turning to Far infrared data, shown in FIG. 9, if instantaneous Far infrared exceeds threshold 312 OR if Far infrared Delta calculated from sample data exceed its threshold delta value 314 for duration D 323, then the visible light fire factor is met 335. Alternatively, if both Far infrared data conditions are met, the visible light fire factor is met 335.

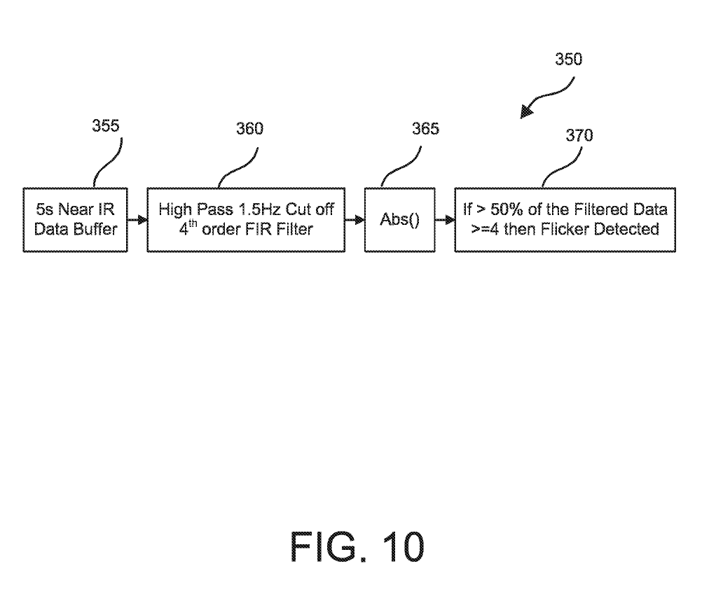

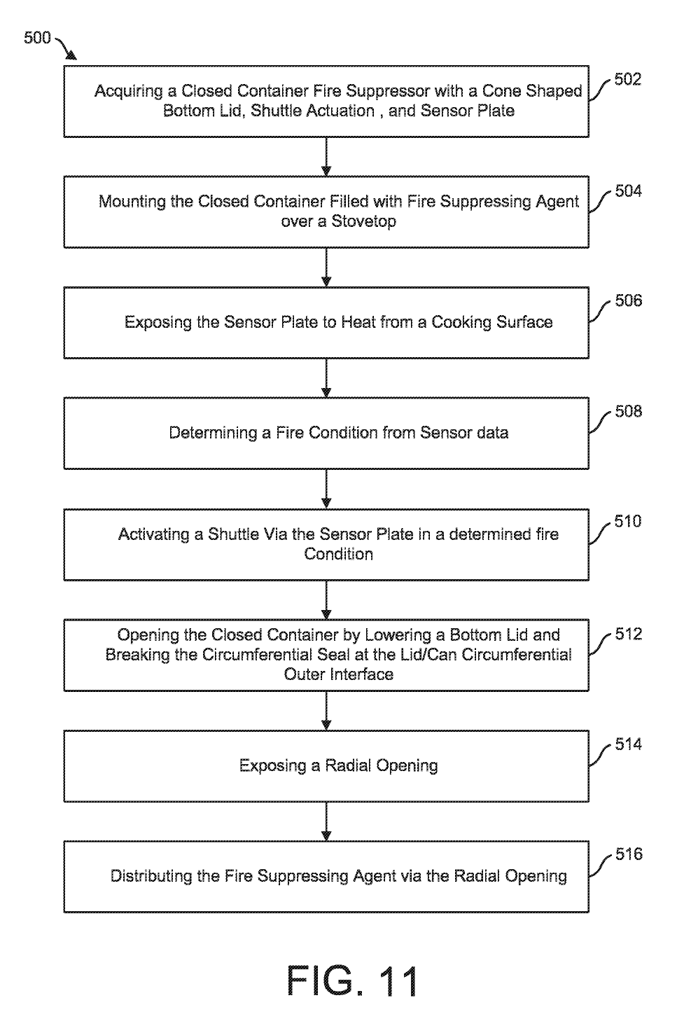

Two more fire factors are assessed for their presence. A flicker presence 316 and an instantaneous Far Infrared temperature are evaluated. The flicker factor is assessed from Near infrared data and is further described with reference to FIG. 10, below. In accordance to an exemplary embodiment, the thermal threshold for the thermopile sensor data is 150 degrees Fahrenheit 318.

A condition of Far infrared exceeding 250 degrees F. 312 will always provide a condition wherein the Far infrared temperature exceeds the 150 degrees F. requisite 318. The 250 Far infrared degrees is an alternate condition to a Delta value of Far infrared at 9 degrees F. per 10 seconds, in which case, the second requirement of Far infrared exceeding 150 degrees F. is not mute.

The exemplary algorithm in FIG. 9 can quickly and accurately identify a grease fire and may discriminate against potential false alarm sources including those ambient lighting, handling the unit and taking it outdoors in field testing or during installation across, for example multiple dwelling units, and even from alcohol fires. Some false triggers maybe user induced such as removing the insulation strip to activate the sensor board connecting it to the battery at one location and then transporting activated sensor boards in stovetop fire suppressors for installation in multiple dwelling units.

In accordance with exemplary embodiments of the present invention, ascertaining a flicker presence is a strong fire indicator and well discriminates from light bulb light sources and steady sunlight; and an exemplary flicker determination method was experimentally verified. Experimentally, the combination of the Far infrared object temperature over a threshold of 150 degrees F., for example, in conjunction with the determination of a fire's flicker from Near infrared sensor data reduced the false fire alarm rate under conditions to include, for example, taking the sensor unit/board outside or placing the sensor unit/board a few inches from a 500 W halogen light.

In accordance with an exemplary embodiment, the Near infrared sensor looks for a rise above a certain threshold in the 940 nm wavelength of light. The 940 nm wavelength works well for detecting grease fire flames.

In accordance with an exemplary method of the present invention, threshold levels may be experimentally determined and may be dependent on or relative to the vertical distance, height, of mounting the stovetop fire suppressor and sensor board mounting position above the cooking surface. In accordance with an exemplary embodiment, the Far infrared object temperature sensor has a fairly wide field of view of near 85 degrees. In accordance with an exemplary method, using the approximately 85 degree field of view sensor, data may be an average of the target cooking pot, or pots, as well as areas of the stove and countertop around them. Threshold levels for the Far infrared object temperature sensor, shown in FIG. 9, were experimentally derived using data collected from the sensor at various vent hood heights.

In accordance with an exemplary embodiment of the present invention, threshold levels are specific to, or relative to, a normal displacement above the cooking surface. For example the minimum object temperature needed to ensure a fire is present is 150 degrees F. While 150 degrees is less than an expected combustion temperature, averaging over the field of view lowers the threshold temperature value of a sensed fired factor present.

In accordance with the present invention, referring again to the exemplary method of FIG. 9, threshold levels discussed below were experimentally evaluated. In alternate embodiments any or all threshold levels, to include threshold values for rate of rise, delta, or level, or duration of level, may be different. Sensor data was collected under numerous fire test conditions with, for example, different sized pans and quantities of oil. Parameter thresholds to include, levels of light or temperature, and rate of change of respective parameters, were experimentally assessed.

In a field implementation experiment, processing was staged to minimize power consumption. With respect to the Near infrared data and flicker detection, a fourth order digital filter was chosen for its tradeoff between processing power and battery life. Alternate embodiments may use different high pass filters. The sensors were sampled at a 4 Hz rate and the data was stored in buffers for processing by the algorithm. Algorithm processing was run on all sampled data. FIG. 9 provides exemplary parameters for data from the different sensors, such as the sensor data value crossing a threshold value for at least a predetermined time duration indicating presence of a fire factor. In an exemplary embodiment of the invention, a set of sensor data 302 to 314, FIG. 9, requires the threshold condition is present for at least 1.25 seconds or the last 5 consecutive samples from a 4 Hz sampling rate. In the case of the Near infrared sensor 302 instantaneous values, for the last 1.25 seconds must be greater than 565 counts.

In accordance with the exemplary method embodiment of FIG. 9, Delta values are a pseudo rate of change of the sensor value in units of degrees F. per 10 seconds. For example, the ambient temperature delta measurement condition 310 would be considered met if the temperature has been increasing by at least 3° F./10 s for the last 1.25 s, across five consecutive samples relative not to the previous sample but relative to the sensor value sample 10 seconds previous to the respective current sample. In the implementation, we computed this value by taking the difference between the current value and the value sampled 10 s earlier, which gives us a rate of change, or a temperature increase, of 3 degrees F. over 10 seconds.

In accordance with an exemplary embodiment, some sensor data is assessed for both a rate of change, delta, threshold as well as an instantaneous threshold value. Fire present condition is met if both or one of the two parameters is/are met. In this manner, if the temperature exceeds the sensing ability of the sensor and the sensor is railed and a rate of rise can no longer be computed from the sensor data, then exceeding the instantaneous threshold will ensure that the sensor will register a fire.

Referring to FIG. 9, visible light is evaluated for an instantaneous value and a Delta value 306. The pseudo rate of change of the sensor value in units of counts per 10 seconds. For example, the visible light delta measurement condition 306 would be considered met if the temperature has been increasing by at least 256 counts/10 s for the last 1.25 s, across five consecutive samples relative not to the previous sample but relative to the sensor value sample 10 seconds previous to the respective current sample, in accordance with an exemplary embodiment.

FIG. 10 is a block diagram of an exemplary method of detecting a presence of a fire's flicker, in accordance with an exemplary embodiment of the present invention. This aspect of embodiments of the invention was experimentally found to be useful in eliminating false alarms from actions such as going outdoors and placing the unit a few inches from a halogen light. Turning to FIG. 10, an exemplary flicker detection method includes: buffering a duration of Near infrared data; filtering the buffered data with a high pass filter 360; taking an absolute value filtered data; and determining if greater than 50 percent of the filtered absolute data exceeds a count 370. If the count is exceeded, a flicker exists 370.

FIG. 10 also provides experimentally verified exemplary values, wherein, 5 seconds of data is buffered 355; the data is high pass filtered with a 4th order filter at a 1.5 Hz cutoff 360; and the absolute value of the filtered data is taken 365; and the result is compared to a value of 4 370. Experimentally, the last 5 seconds of sensor data, which in one implementation was 20 samples at 4 Hz, was high pass filtered. More particularly, a MATLAB® digital 4th order high pass filter (Mathworks, Inc., Natick, Mass., USA) with a cutoff frequency of 1.5 Hz was designed and the data was filtered using the same. The filter had the following coefficients, as provided below in Table 1.

TABLE 1
Filter Coefficients

−0.02001953125
−0.264617919921875
0.568267822265625
−0.264617919921875
−0.02001953125.

In an experimental implementation, coefficients were scaled to fixed point for operation within the exemplary microcontroller, which does not natively support floating point calculations. Then, the absolute value of the resulting filtered data was calculated to eliminate the need to look for positive and negative values. Lastly, the 20 consecutive data samples, sampled at 4 Hz over 5 seconds were reviewed the number of values greater than or equal to an analog to digital output count of 4 were summed. If greater than 50 percent of samples, for example 10 or more samples out of 20, are greater than the 4 count, then a determination that the object is flickering is made. Conditions for determining the presence of flicker were experimentally derived.

The bottom block in the exemplary method of FIG. 9 assesses whether the current value of the far infrared temperature sensor 318 is greater than 150 degrees F. In accordance with an exemplary embodiment, this condition must be met for a fire condition to be detected. This parameter may serve to mitigate a false alarm issue where the unit is brought outdoors. It was found experimentally that the exemplary sensor board and fire detection method indicates a temperature over 150 degrees F. when there is a fire but indicates a temperature less than 150 degrees consistently when the sensor board is taken outside on a hot day. In accordance with alternate embodiments, this temperature value may be adjusted, set to a different value. A condition of Far infrared exceeding 250 degrees F. 312 will always provide a condition where the Far infrared temperature exceeds the 150 degrees F. requisite, however, should the alternate condition of a pseudo rate of change of Far infrared at 9 degrees F. per 10 seconds 314 be present, the requirement of Far infrared exceeding 150 degrees F. 318 is not mute.

Referring again to FIG. 9, the exemplary method further includes: setting a Fire State 345 when it is determined that six fire factors are concurrently present 340. A Far infrared instantaneous temperature must exceed 150 degrees F., where a duration is not required 318. The presence of flicker must be determined 316, and a Near infrared sensor value must exceed 565 counts 302 for the duration D 323. Either instantaneous visible light must exceeds threshold 304 or 325 visible light delta must exceed its threshold delta value 306 for duration D 323, or both are exceeded 325. Turning to ambient temperature, instantaneous ambient temperature data must exceed threshold 308 or 330 ambient temperature delta calculated must exceed its threshold delta value 310 for duration D 323, or both conditions must be met 330. Turning to Far infrared data, either instantaneous Far infrared must exceed its threshold 312 or 335 Far infrared calculated Delta must exceed its threshold delta value 314 for duration D 323, or both Far infrared data conditions must be met 335.

In alternate embodiments of the present invention, either a 150 degrees F. sample on the Far infrared sensor 318 or the presence of flicker 316, will determine a fire condition and trigger a stovetop fire suppressor 100, alternate embodiments not shown. It was shown experimentally that the flicker algorithm provided a discriminator between presence of an actual flame and a strobe like effect independent of a presence of a fire.

While embodiments directed towards a self-contained above the stove mounted fire suppressor are provided herein, alternate sensor detection and activation of devices are within the scope of the present invention. For, example, in alternate embodiments, the sensor board 170, as shown in FIG. 2, may be mounted on a wall behind the stove. The change in mounting would afford a different sensor board layout, different sensor board dimensions, and different power source. Further, additional components or expanded capacity could be incorporated, such as increased memory. With a larger battery power supply, such as C or D batteries, a faster power consuming processor rate may be employed. The sampling rate could increase 10 or even 250 fold. For applications mounted on a wall, a hard wired power source could be used.

In accordance with still alternate embodiments, fewer than 5 consecutive samples are used. In an exemplary embodiment, two consecutive samples of a Near infrared sensor, a Visible Light sensor, an Ambient temperature sensor, and/or a Far infrared sensor are compared to instantaneous and/or Delta thresholds. In still alternate embodiments, said two samples are taken at 2 hertz, decreasing the time duration to 0.5 seconds. In another embodiment three consecutive samples are evaluated at 2 hertz for a time span of 1 second duration for detection of fire factor present. Embodiments of the present invention can readily include sampling rates of 2 hertz to 20 hertz. Number of consecutive samples evaluated for condition present can range from 2 to 20 in embodiments of the present invention. The duration for condition present, in accordance with embodiments of the present invention, may range from a fraction of a second to 2 seconds.

In accordance with an exemplary embodiment, threshold levels increase with an increase in displacement of the sensors from the cooking surface, such as may occur with a back wall mounted sensor board. A change in orientation of the sensors relative to the cooking surface may also alter the threshold values. In still alternate embodiments, the sensor combination may be displaced from the fire suppressor and activate a wireless trigger to release the fire suppressing agent.

In accordance with alternate embodiments, the sensor board 170, shown for example in FIG. 6, is designed to be mounted along the sidewalls of a self-contained stovetop fire suppressor, not shown. The orientation of the sensors to and distance from the cooking surface, when mounted for use, could be very close to that of the embodiment shown in FIGS. 5A-5C. In turn, threshold values near those used in the presently presented experiments may be employed.

Exemplary embodiments of the present invention include system event logging. The sensor board logs a multitude of events, which may prove useful in determining what happened in the event of a fire. The logs may be accessed via a password protected serial interface on the sensor board or by accessing the processor's memory through a boot loader programmer. The data is times tamped using a time since the unit was powered on. The events that are logged include: Boot up Self Test Results, when batteries are installed; Automatic Weekly Self Test Results; User Commanded Self Test Results; User Silencing the Low Battery Alert; and the sensor data used to make a determination of fire detection and trigger the fire suppressing unit.

Aspects of the present invention may include fire detection hardware, algorithms, and processor disconnects hardware 212, as shown for example in FIG. 7, to minimize or eliminate a brownout condition. Additional embodiments of the present invention may incorporate power sources other than battery power housed within the fire suppressor unit. Embodiments of the sensor board invention described herein have been illustrated with, for example, the stovetop fire suppressor embodiment of FIG. 4. Embodiments of the sensor board invention described herein may be used in conjunction with alternate stovetop fire suppressors, conventional suppressors and those forthcoming. Such alternate self-contained fire suppressor containers, which may be employed in alternate embodiments of the present invention, include a conventional stovetop fire suppressor with scored bottom petals. Such conventional fire suppressor could be employed in embodiments of the present invention by altering the mounting of the sensors, for example, along the can's circumferential periphery, to facilitate activation by an initiator charge versus a shuttle activation. In still alternate embodiments, the positioning of the sensors could be similar to that shown in FIGS. 5A-5C but drop off with an activation sequence.

FIG. 11 is a block diagram of a method of activating a stovetop fire suppressor 500, in accordance with an exemplary embodiment of the present invention. The exemplary method includes: acquiring a closed container fire suppressor with a cone shaped bottom lid, a shuttle actuation mechanism, and a sensor plate 502; mounting the closed container filled with fire suppressing agent over a stovetop 504; exposing a sensor plate to heat from a cooking surface 506 and determining a fire condition from the sensor data 508; and activating a shuttle via the sensor plate in a determined fire state 510. In accordance with an exemplary embodiment, an E-match is used trigger the shuttle. In accordance with an exemplary embodiment, a microcontroller evaluates sensed data; and activates a firing circuit when a fire condition is determined. Returning to FIG. 11, the method further included: opening the closed container by lowering a bottom lid and breaking the circumferential seal at the lid/can circumferential outer interface 512; exposing a radial opening 514 distributing the fire suppressing agent via the radial opening 516.

Embodiments of the present invention are designed to operate for 5-7 years on one pair of N batteries. This long term service life is achieved, at least in part, by custom and product specific power management techniques.

Combinations of sensors and their effectiveness were experimentally tested. An exemplary sensor combination and method, for example shown in FIG. 9, affords low cost and reliable fire detection, while discriminating a fire condition from stovetop related false alarms. Embodiments of the present invention can detect a grease fire in various sized pots and pans while discriminating against alcohol flames, which may be cooler, dimmer and emit different wavelengths of light. Such alcohol flames may occur at a stovetop when making things like bananas foster. Some common heat or light conditions have been experimentally distinguished from a fire condition, in accordance with the sensors, system, and method of exemplary embodiments of the present invention. Experimental results yield accurate fire detections with discrimination from: alcohol flames; flames from the burners on a gas stove; electric stove burners; boiling water; lots of steam; ambient lighting changes while cooking; strobe lights; and camera flashes. In addition, the sensor combination performs accurately in various lighting sources to include: incandescent, halogen, light emitting diodes and fluorescent.

These and other advantages of the invention will be further understood and appreciated by those skilled in the art with reference to the written specification, the claims and the appended drawings. While specific alternatives to steps of the invention have been described herein, additional alternatives not specifically disclosed but known in the art are intended to fall within the scope of the invention. Thus, it is understood that other applications of the present invention will be apparent to those skilled in the art upon reading the described embodiments and after consideration of the appended drawings.

What is claimed is:

1. An automatic stovetop fire suppressor, the device comprising:
a plastic cone shaped bottom lid secured to a bottom of a can and forming a closed container with the can;
a fire suppressing agent housed in the closed container;
a combination of light and heat sensors mounted on a sensor board;
a microprocessor mounted on the sensor board analyzing sensor data;
the sensor board housed beneath the cone shaped bottom lid; and
a shuttle actuating the automatic stovetop fire suppressor when the microprocessor analysis finds a fire condition.

2. The device according to claim 1, further comprising:
a near infrared sensor.

3. The device according to claim 1, further comprising:
an ambient temperature sensor.

4. The device according to claim 1, further comprising:
a thermopile sensor or a far infrared object sensor.

5. The device according to claim 1, further comprising:
a visible light sensor.

6. The device according to claim 2, wherein:
The near infrared light sensor is a phototransistor sensitive to a 940 nm wavelength.

7. The device according to claim 6, further comprising:
a daylight filter.

8. The device according to claim 1, further comprising:
an ambient temperature sensor;
a far infrared object sensor;
a visible light sensor; and
a near infrared light sensor.

9. The device according to claim 8, further comprising:
a phototransistor sensor sensitive to a 940 nm wavelength; and
a daylight filter applied to input light on the phototransistor.

10. The device according to claim 9, further comprising:
a two 1000 mAh 1.5 V N cell batteries.

11. The device according to claim 1, further comprising:
a microcontroller mounted on the sensor board receiving sensor data; and
a microcontroller output connected to an electric match.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A method of detecting a stovetop fire, the method comprising:
assessing the concurrent presence of six factors, wherein:
the six factors comprise:
near infrared sampled counts exceed 565 counts;
instantaneous visible light samples exceed 565 counts, or a pseudo visible light rate exceeds 256 counts per 10 seconds;
instantaneous ambient temperature sampled value exceeds 185 degrees F., or a pseudo ambient temperature rate of rise exceeds 0.3 degrees F. per second, or a pseudo ambient temperature rate of rise exceeds 3 degrees per 10 seconds;
instantaneous far infrared values exceed 250 degrees F., or a pseudo rate of Far infrared rise exceeds 9 degrees F. per 10 seconds;
a flicker is determined to be present; and
an instantaneous Far infrared sampled value exceeds a 150 degree F. threshold.

41. A self-contained fire suppressor with sensor activation, the suppressor comprising:
a bottom lid secured to a bottom of a can and forming a closed container with the can;
a fire suppressing agent housed in the closed container;
at least one infrared sensor, at least one visible light sensor, and at least one ambient temperature sensor mounted on a sensor board;
a microprocessor mounted on the sensor board analyzing sensor data;
the sensor board secured to the self-contained fire suppressor closed container or to another housing.

42. The device according to claim 41, further comprising:
at least one near infrared sensor; and
at least one far infrared sensor.

43. A self-contained fire suppressor device, the device comprising:
a bottom lid secured to a bottom of a can and forming a closed container with the can;
a fire suppressing agent stored in the closed container;
at least one or more sensors comprising at least one infrared sensor, at least one visible light sensor, and at least one ambient temperature sensor to collect sensor data related to fire condition;
a microcontroller to analyze the sensor data received from the sensors to detect the fire condition; and
an activation mechanism triggered by the microcontroller to open the bottom lid, thereby releasing the fire suppressing agent upon confirmation of the fire condition.

44. The device according to claim 1, further comprising:
an electronic match in tandem with a heat sensitive fuse for triggering the activation mechanism to open the bottom lid.
